(19) United States
(12) Patent Application Publication
(10) Pub. No.: US 2024/0270310 A1
(43) Pub. Date: Aug. 15, 2024

(54) ZERO TURNING RADIUS MOWER STEERING SENSOR LINKAGE

(71) Applicant: DEERE & COMPANY, MOLINE, IL (US)

(72) Inventors: MANISH K. SHARMA, Alwar (IN); SARAVANAN DEENADAYALAN, Chengalpattu (IN); RAJESAHEB A. BAGWAN, Bijapur (IN)

(21) Appl. No.: 18/168,702

(22) Filed: Feb. 14, 2023

(51) Int. Cl. B62D 11/04; A01D 34/00; A01D 34/78; A01D 34/82; B62D 1/12

(52) U.S. Cl. CPC B62D 11/04; A01D 34/006; A01D 34/78; A01D 34/824; B62D 1/12; A01D 34/64; A01D 2101/00

(57) ABSTRACT

A zero turning radius mower steering sensor linkage includes a steering lever rotating between a forward position and a reverse position on a steering lever axis; a rotary sensor rotating between a forward position and a reverse position on a rotary sensor axis displaced from the steering lever axis; and a rotary link connected between the steering lever and rotary sensor to command a rotational speed of a drive wheel motor based on the steering lever position.

### FIELD OF THE INVENTION

This invention relates to grass mowing machines, and specifically to zero turning radius (“ZTR”) mowers having independently powered left and right drive wheels controlled by a pair of steering arms.

### BACKGROUND OF THE INVENTION

Grass mowing machines known as zero turning radius (ZTR) mowers have at least one independently powered drive wheel on each side of a frame. One drive wheel may be operated in a forward direction while the other drive wheel may be stopped or operated in reverse. Many ZTR mowers have a twin stick control system. A pair of steering arms or control levers may be provided side-by-side, with each steering arm controlling one of the drive wheels. When both steering arms or control levers are advanced together forwardly out of their neutral position, both drive wheels rotate forwardly to cause the mower to move forward. A ZTR mower may be steered by advancing one steering arm or control lever more than the other.

Typically, each steering arm or control lever on a ZTR mower may be linked to a pump arm of one of two separate hydraulic pumps, or of a dual hydraulic pump; i.e., a separate pump for each wheel. The steering arm or control lever may be used to move a pump swash plate through a direct linkage, or provide drive signals to an electric motor.

The steering arms or control levers on a ZTR mower may be mounted on the vehicle frame so that each has a first or forward/reverse pivot axis allowing the steering arm or control lever in the operating position to pivot forwardly in an arc to turn the wheel in forward, or pivot rearwardly to turn the wheel in reverse. Additionally, when a steering arm or control lever is in neutral, between forward and reverse, the operator may pivot it outwardly on a second pivot axis. The ZTR mower may stay in neutral when the steering arms or control levers are pivoted outward.

Some ZTR mowers have steering arms or control levers to provide position signals to rotary sensors. However, it may not be possible to mount the rotary sensor on the same axis as the steering arm. A linkage is needed to convert the movement of the steering arm to the rotational motion of the rotary sensor.

### SUMMARY OF THE INVENTION

A zero turning radius mower steering sensor linkage includes a cam profile bracket attached to a zero turning radius mower steering lever and pivoting with the steering lever on a steering lever axis. A rotary link is connected between a cam slot in the cam profile bracket and a rotary sensor. The rotary link slides in the cam slot to pivot the rotary sensor on a rotary sensor axis displaced from the steering lever axis to control the speed of a rear wheel motor of the zero turning radius mower.

### BRIEF DESCRIPTION OF THE DRAWINGS

FIG. 1 is a perspective view of a ZTR mower with a zero turning radius mower steering sensor linkage according to a first embodiment of the invention.

FIG. 2 is a front perspective view of a zero turning radius mower steering sensor linkage with the steering lever in a forward position according to a first embodiment of the invention.

FIG. 3 is a rear perspective view of a zero turning radius mower steering sensor linkage with the steering lever in a forward position according to a first embodiment of the invention.

FIG. 4 is a rear perspective view of a zero turning radius mower steering sensor linkage with the steering lever in a rearward position according to a first embodiment of the invention.

### DESCRIPTION OF THE PREFERRED EMBODIMENT

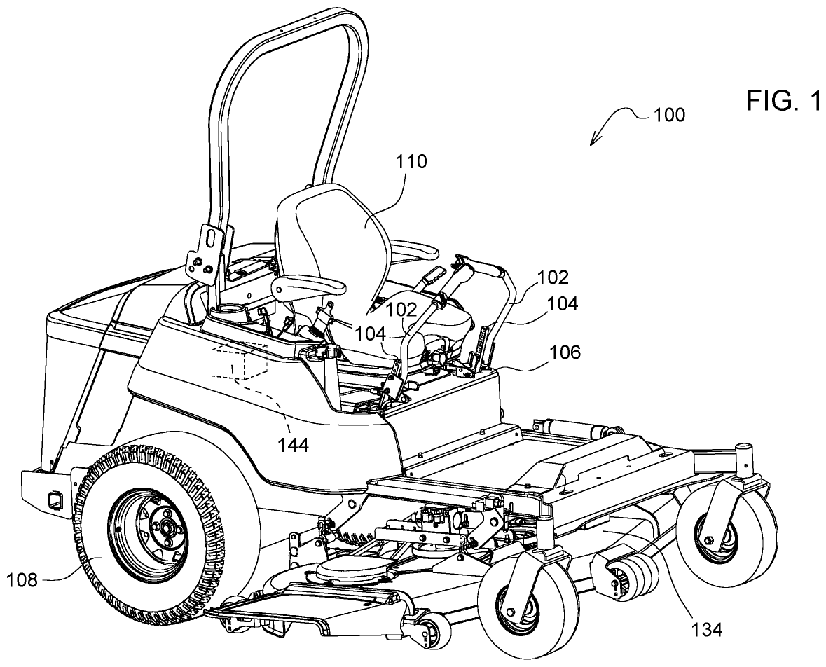

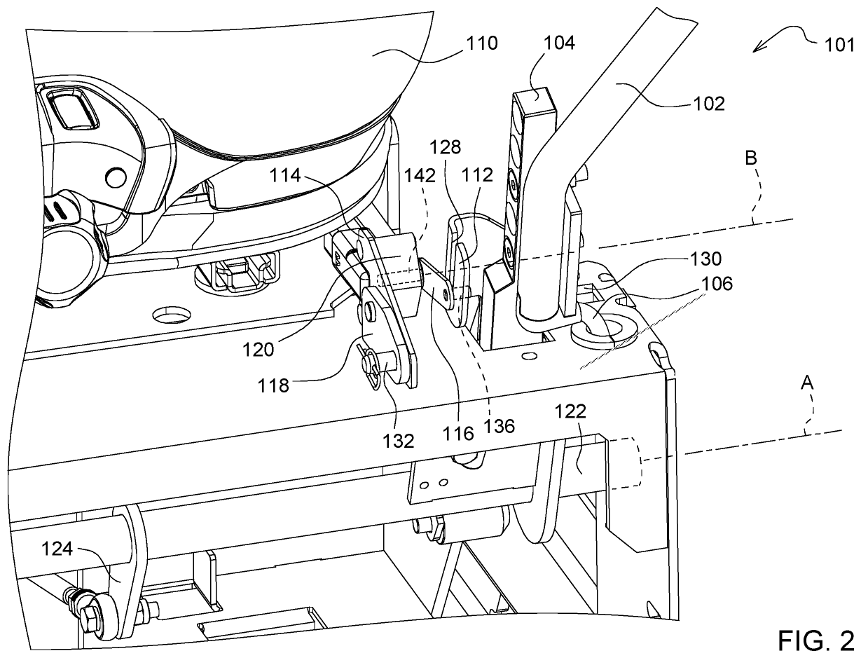

In a first embodiment of the invention shown in FIGS. 1-4, zero turning radius (ZTR) mower 100 may have a pair of control arms 102, each control arm attached to a steering lever 104. Each steering lever 104 may be pivotably mounted to a side of the operator platform 106 alongside operator seat 110. The movement of each steering lever 104 may be limited by T-shaped channel 130. For example, the pair of control arms and steering levers may pivot as described in U.S. Pat. No. 9,510,503 for Grass Mowing Machine Operator Platform owned by Deere & Company, or a similar structure. The ZTR mower also may have a power unit behind the operator platform, and a mower deck 134 mounted to the frame members below and forwardly of the operator platform. Each steering arm and control lever may rotate on a steering lever axis and may be used to control one of the rear drive wheels 108. The steering lever axis is identified in the drawings as Axis A, and is also shown as pivotable rod 122. The rotation of rod 122 may be dampened by one or more shock absorbers. Additionally, rod 122 may be used to actuate other functions using bell cranks 124 attached thereto.

In one embodiment, ZTR mower 100 may include a pair of steering sensor linkages 101, each steering sensor linkage between a steering lever 104 and rotary sensor 120. Each steering lever 104 may pivot or rotate on the steering lever axis, and each rotary sensor 120 may pivot or rotate on a different rotary sensor axis that is displaced from the steering lever axis. The rotary sensor axis is identified in the drawings as Axis B. For example, each steering lever 104 may pivot or rotate forward on the steering lever axis up to a maximum angle of about 20 degrees from neutral, and rearward up to a maximum angle of about 10 degrees from neutral, as limited by T-shaped channel 130. Each rotary sensor 120 may have a shaft 142 that pivots or rotates on the rotary sensor axis. Each rotary sensor 120 may provide electrical signals through cable 146 to vehicle controller 144 based on the position of shaft 142 on the rotary sensor axis. Vehicle controller 144 may command electric traction drive motors for the left or right rear wheels 108 at speed or torque values based on signals from the rotary sensors.

In one embodiment, each steering sensor linkage 101 may include cam profile bracket 112 attached to steering lever 104. Cam profile bracket 112 may be a sheet metal body having a generally linear cam slot 128. Cam profile bracket 112 may be attached to steering lever 104 such that the cam profile bracket may pivot or rotate with the steering lever on the steering lever axis. When steering lever 104 is pivoted to forward or reverse positions, cam profile bracket 112 also pivots to those positions which changes the orientation of cam slot 128. Cam profile bracket 112 may be attached to steering lever 104 using pivotable connector 140 allowing the cam profile bracket to pivot or rotate with the steering lever in forward or reverse even if the steering lever also is moved outward or sideways in T-shaped channel 130 toward the outside of operator platform 106.

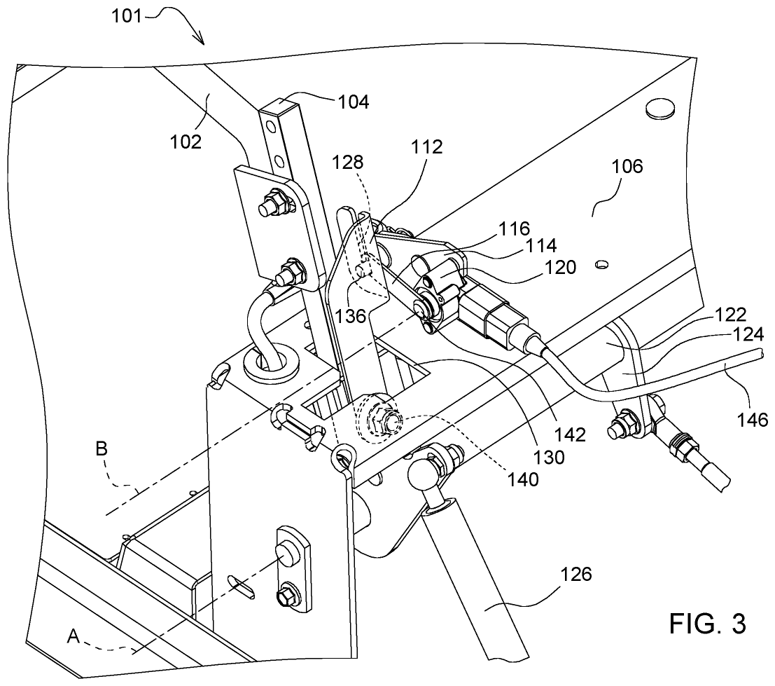

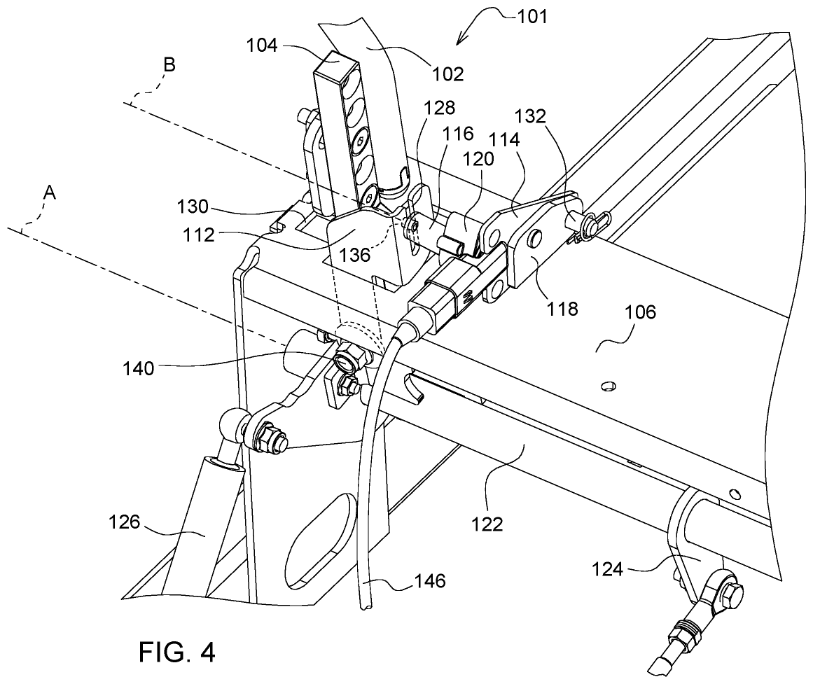

In one embodiment, each steering sensor linkage 101 may include rotary link 116 in sliding engagement with cam slot 128. For example, pin 136 may extend laterally from a first end of rotary link 116 into cam slot 128. When steering lever 104 pivots or rotates on the steering lever axis, pin 136 is forced to slide along cam slot 128. For example, FIG. 3 shows steering lever 104 pivoted forward, forcing pin 136 toward a lower end of cam slot 128, and FIG. 4 shows steering lever 104 pivoted rearward, forcing pin 136 near an upper end of cam slot 128.

In one embodiment, each steering sensor linkage 101 may include rotary sensor 120 which provides signals to vehicle controller 144 based on the angular position of its shaft 142 on the rotary sensor axis. Rotary sensor 120 may be a potentiometer which may be mounted to the upper surface of operator platform 106 using sensor mounting bracket 114. For example, sensor mounting bracket 114 may be attached to plate 118 by one or more pins 132. Rotary sensor shaft 142 may be connected to a second end of rotary link 116. The position of rotary sensor shaft 142 may depend on the alignment of rotary link 116 based on the location of pin 136 in cam slot 128.

Having described the preferred embodiments, it will become apparent that various modifications can be made without departing from the scope of the invention as defined in the accompanying claims.

1. A zero turning radius mower steering sensor linkage, comprising:
a cam profile bracket attached to a zero turning radius mower steering lever and pivoting with the steering lever on a steering lever axis; and
a rotary link connected between a cam slot in the cam profile bracket and a rotary sensor; the rotary link sliding in the cam slot to pivot the rotary sensor on a rotary sensor axis displaced from the steering lever axis to control the speed of a rear wheel motor of the zero turning radius mower.

2. The zero turning radius mower steering sensor linkage of claim 1 wherein the cam profile bracket is pivotably mounted to the /steering lever.

3. The zero turning radius mower steering sensor linkage of claim 1 further comprising a pin on the rotary link which slides in the cam slot.

4. The zero turning radius mower steering sensor linkage of claim 1 wherein the cam profile bracket has a first surface attached to the steering lever and a second surface with a cam slot.

5. The zero turning radius mower steering sensor linkage of claim 1 wherein the cam slot is linear.

6. A zero turning radius mower steering sensor linkage, comprising:
a steering lever rotating between a forward position and a reverse position on a steering lever axis;
a rotary sensor rotating between a forward position and a reverse position on a rotary sensor axis displaced from the steering lever axis; and
a rotary link connected between the steering lever and rotary sensor to command a rotational speed of a drive wheel motor based on the steering lever position.

7. The zero turning radius mower steering sensor linkage of claim 6, further comprising a cam profile bracket attached to the steering lever; the rotary link slidably attached to the cam profile bracket.

8. The zero turning radius mower steering sensor linkage of claim 7 wherein the rotary link includes a pin engaging a slot in the cam profile bracket.

9. The zero turning radius mower steering sensor linkage of claim 7 wherein the cam profile bracket is pivotably attached to the steering lever.

10. A zero turning radius mower steering sensor linkage, comprising:
a cam profile bracket mounted to a steering lever; and
a rotary link slidably connected between the cam profile bracket and a shaft of a rotary sensor which controls a traction drive motor speed.

11. The zero turning radius mower steering sensor linkage of claim 10 wherein rotary link is slidably connected to a cam slot in the cam profile bracket.
